(19) United States
(12) Patent Application Publication
(10) Pub. No.: US 2006/0098623 A1
(43) Pub. Date: May 11, 2006

(54) Voice data security method and apparatus

(76) Inventors: Andrew D. Christian, Lincoln, MA (US); Brian L. Avery, Lexington, MA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/983,438

(22) Filed: Nov. 8, 2004

(51) Int. Cl. H04L 12/66

(52) U.S. Cl. 370/352

(57) ABSTRACT

A voice data security method and apparatus of the present invention modifies a subject voice data stream. Modification is by insertion of noise or similar interference effects. The amount of audio distortion is controllable. Audio or voice communications over a data network are thus made secure, and unauthorized use of the data network over voice channels is prevented.

### BACKGROUND OF THE INVENTION

Today various personnel of large companies or in corporate settings use computers. Many of these people like to have access to computer services outside of the corporate setting (e.g., web sites, e-mail, and chat rooms). To enable outside access, the corporate information technology (IT) staff sets up firewalls and bastion hosts between the internal and external networks that prevent unauthorized use or entry, yet still allow employees access to useful network resources.

For example, company ABC's IT policy can be approximated as: (a) internal machines are allowed to directly initiate TCP connections to external machines on a specific subset of TCP ports, (b) internal machines may be allowed to use approved proxy hosts for accessing a more general set of external services (e.g., web access), (c) external machines are allowed to tunnel into the company's network only if they have provided appropriate authentication and are running IT-approved software configurations, and (d) e-mail from external machines is routed through appropriate bastion hosts and scanned for viruses. It is important to note that the only unauthenticated form of communication that is initiated by an external party is e-mail, accordingly e-mail is carefully checked before being delivered to employees to ensure security of ABC's (the company) network.

Now consider the problem with respect to voice-over-internet protocol (VoIP). The VoIP telephone or VoIP-enabled computer is on an employee's desk and belongs to the internal corporate network. However, to be useful as a telephone, this same device should be able to receive VoIP telephone calls from people outside of the corporation (e.g., external call). Typically this functionality is implemented by placing a bastion host at the firewall that receives incoming telephone calls and forwards them to the appropriate internal VoIP equipment.

An incoming VoIP telephone call consists of two logical parts: a signaling channel and a bi-directional voice (audio communication) data stream. Current bastion host technology processes the signaling channel and verifies that it appears to be an honest telephone call before passing it on to the end client. However, the voice or media data stream is forwarded without any further security measures. An example of this is, no determination is made to ensure that the data/media stream is in fact what it purports to be, i.e., an audio telephone call or voice data.

The natural concern of IT staffs in general is that the voice data stream could be used for something other than voice data. It is plausible that an individual outside of the corporation could send a corrupted media stream to an internal VoIP client and attempt to exploit buffer-overrun attacks or other known problems with internal clients. For example, some VoIP telephones or soft telephones (software operating as telephones) have been known to reboot upon receiving a bad data stream. In addition, many soft telephones have known problems that can result in unintended actions on a client machine, such as running out of memory or greatly slowing down the machine. Given these known problems, it is not implausible that someone could inject a virus or remotely gain access to an improperly secured client machine using a voice data stream.

Current firewall and bastion host implementations act as gatekeepers but do not modify or validate the voice data stream, so there are no safeguards once the call has been set up and the media stream established. The present invention provides such safeguards for both incoming and outgoing audio data streams.

A somewhat similar type of data handling may be found in other fields. For example, web proxy servers may inspect and modify or delete elements from HTTP data streams. Further, some e-mail servers may be configured to delete viruses from e-mail or detect and delete spam.

### SUMMARY OF THE INVENTION

There is a need for solutions that implement audio communication security by modifying the subject data streams. The present invention provides such a voice data security system and method. In particular, the present invention provides audibly insignificant transmogrification of voice communications over data networks to prevent unauthorized usage of the network.

In one embodiment of the present invention, the voice data security system includes a voice data stream and a signal modification engine responsive to the voice data stream, the signal modification engine modifying the voice data stream in a manner such that the amount of audible distortion to the voice data stream is controllable. The signal modification engine can introduce noise data, frequency noise data, and/or phase shift noise data into the voice data stream. The signal modification engine can also apply time dithering to the voice data stream. If desired, the amount of time dithering can maintain frequency content of the voice data stream. The signal modification engine can modify a silence duration of the voice data stream.

The signal modification engine can further decode the voice data stream to a common format prior to modifying the voice data stream, and can encode the voice data stream after modifying the voice data stream. The signal modification engine encoding the voice data stream can restore the voice data stream to the original encoding format. Further, the signal modification engine can transcode the voice data stream to a different format for the voice data stream.

The signal modification engine can provide the modified voice data stream to a telephony network. The telephony network can include voice-over IP equipment.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a schematic view of a VoIP network employing voice data security of the present invention.

FIG. 2 is a schematic view of a VoIP network with a firewall directing the subject voice data stream, the network employing an embodiment of the present invention voice data security.

FIG. 3 is a flow chart of the present invention voice data security process which includes modification of a subject voice data stream.

FIG. 4 is a block diagram of a signal modification engine of the present invention.

FIG. 5 is a block diagram of a signal modification engine of another embodiment of the present invention which decodes and re-encodes the voice data stream during the process of generating a secured voice data stream.

### DETAILED DESCRIPTION OF THE INVENTION

The present invention provides a low-cost solution that directly prevents unauthorized use of a data network over voice channels. It prevents many direct attacks on receiving audio communication equipment by protecting directly against standard attacks that rely on the integrity of the data stream. For example, a standard buffer-overflow attack relies on being able to insert a small piece of valid machine code in a known location outside of the data buffer. This invention modifies the data stream to the point that this form of attack is not practical.

By way of general overview, one embodiment of the present invention includes a computer having one or more network interfaces (e.g., high speed) and a signal modification engine. The signal modification engine modifies audio streams in such a way as to be virtually undetectable to a human listener. The signal modification engine may work directly on the encoded audio data stream, or may optionally decode the audio data stream to a common format, introduce the modifications and re-encode the audio data stream to either the original format or a different format. The audio data stream modifications may include any or all of the following (but are not limited to): (1) introduction of a small quantity of “white” or audio noise, (2) introduction of a small amount of time dithering (e.g., expanding and contracting small time slices), (3) introduction of a small amount of time dithering without modifying frequency content, (4) introduction of a small quantity of frequency shift noise, (5) introduction of a small quantity of phase shift noise, and (6) introduction of small changes in silence duration.

In general, the audio data stream modifications can be treated as some generalized digital filter applied against the audio data stream with the objective of changing the underlying data bits without noticeably degrading the audio quality. The amount of degradation can be varied to suit the use and security requirements of the installation, i.e. controllable degradation. If an initial audio stream is true audio data, a human receiving the invention modified audio stream will, at worst, think that the telephone connection is not as clear as it should be. On the other hand, a random bit pattern (of the present invention) introduced into a virus in the process of being transferred will almost certainly prevent the virus from succeeding.

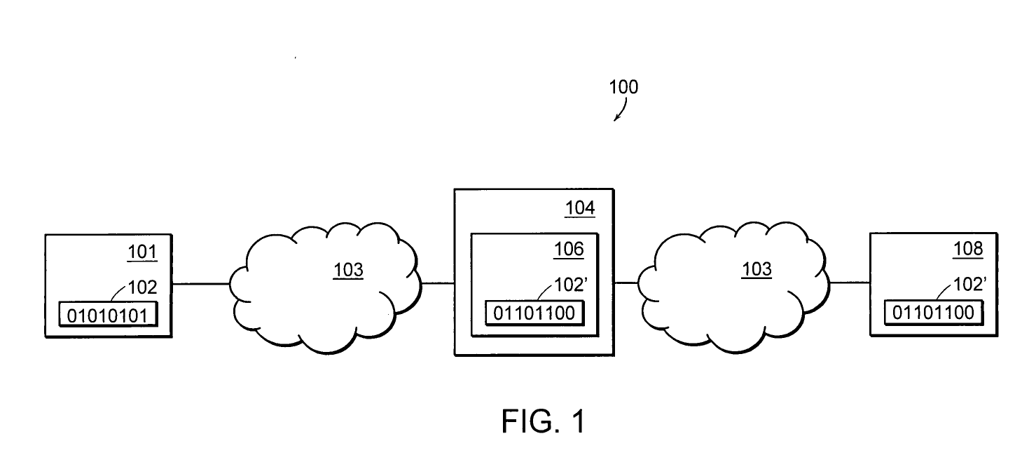

FIG. 1 is illustrative. In FIG. 1, a VoIP network 100 carries a subject voice data stream 102 initiated from a VoIP device 101. The voice data stream 102 is indicative of a voice or audio communication (e.g., incoming or outgoing phone call). In one embodiment, the voice data stream 102 is sent to or received by (through a routing network 103) an invention voice data security system 104 for processing using a high-speed network interface (not shown). Similarly, in another embodiment of the present invention, system 104 may have more than one high-speed network interface.

The voice data security system 104 includes a signal modification engine 106. The signal modification engine 106 is responsive to the received voice data stream 102 and modifies voice data stream 102 to a modified voice data stream 102′. After modifying voice data stream 102, the signal modification engine 106 forwards (through a routing network 103) the modified voice data stream 102′ to a VoIP device 108. The VoIP device 108 can be a VoIP telephone and/or VoIP enabled computer system. In one embodiment, the voice data stream can be transmitted over the same routing network 103. The routing network 103 can be the internet, intranet, or other known routing network.

In another embodiment, after receiving the resulting voice data stream 102′, a computer system can establish a telephone connection such that the incoming/outgoing phone call can be received at a corresponding VoIP device 108. Thus, the signal modification engine 106 forwards (through the routing network 103) the resulting (modified) voice data stream 102′ to a component of the network 100 for connection, i.e., receiving the incoming/outgoing telephone call. It should be understood that the network 100 can be a bidirectional network or a unidirectional network.

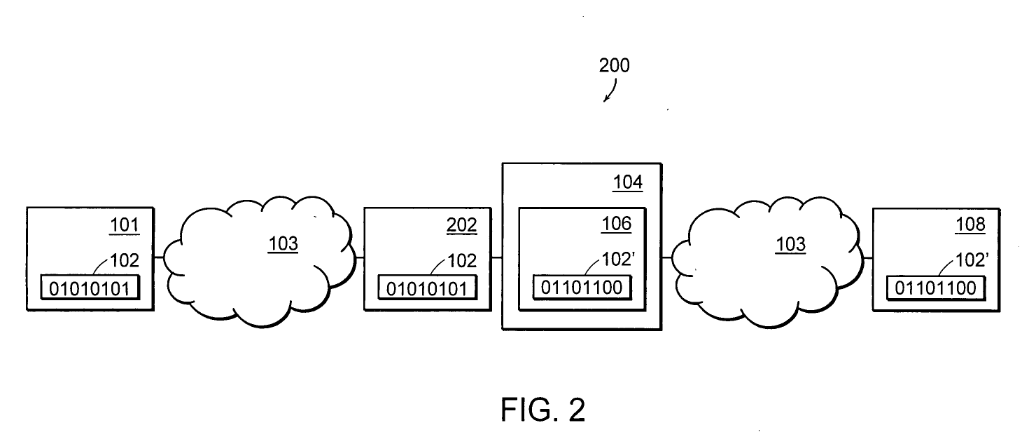

FIG. 2 is a diagram of a VoIP network 200 employing voice data security of the present invention and using a firewall 202 to the direct voice data stream 102. In one embodiment, the firewall 202 initially receives (through the routing network 103) and then directs the voice data stream 102 to the signal modification engine 106 for security processing (i.e., modification). After processing voice data stream 102, the signal modification engine 106 can return the processed or modified voice data stream 102′ to the firewall 202 for forwarding or the signal modification engine 106 can forward the modified voice data stream 102′ directly. The firewall 202 or the signal modification engine 106 then directs the security processed/modified voice data stream 102′ to the appropriate destination in the same way as described for FIG. 1.

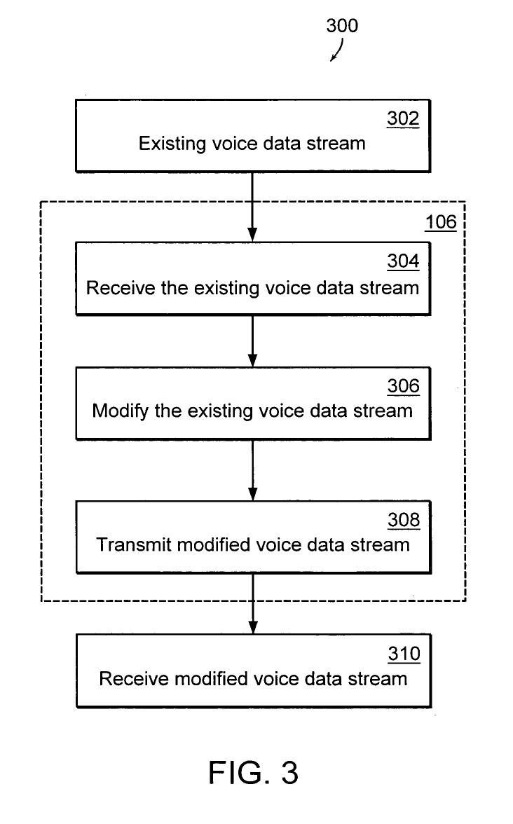

FIG. 3 is a flow diagram 300 of the signal modification engine 106 (of FIG. 1) process of modifying a voice data stream 102. At step 302, a voice data stream 102 exists on a network. The voice data stream 102 is received by the signal modification engine 106 in step 304. Upon receiving the voice data stream 102, the signal modification engine 106 modifies the voice data stream 102 by introducing interferences or noise (step 306) into the voice data stream 102. At step 308, the signal modification engine 106 delivers to an appropriate destination (step 310); a modified voice data stream 102′ having audio differences. The amount of degradation of the audio differences is controllable. In this way, the voice data stream 102 is made secure without noticeably degrading audio quality.

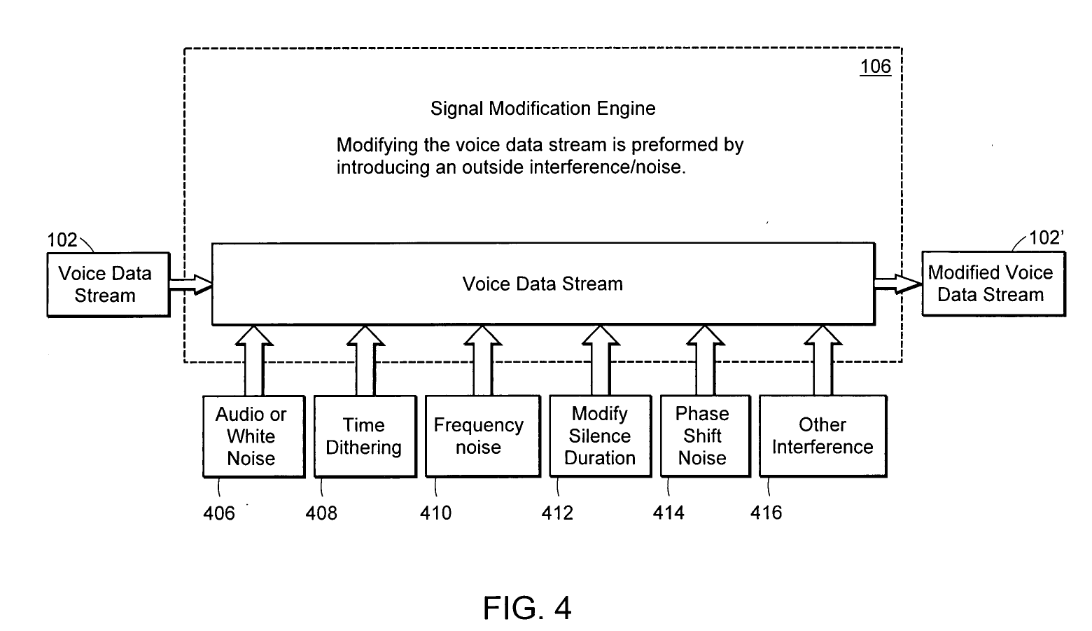

Referring to FIGS. 1 and 2, a voice data security system 104 employs a signal modification engine 106 to modify a voice data stream 102 by inserting noise or interference into the voice data stream 102. An expanded view of the signal modification engine 106 is shown in FIG. 4. In one embodiment, as illustrated in FIG. 4, the signal modification engine 106 introduces a single interference or type of suitable noise. Examples include, but are not limited to: (1) introduction of a small quantity of audio or white noise 406, (2) introduction of a small amount of time dithering 408 for expanding and contracting small time slices, (3) introduction of a small amount of time dithering 408 for expanding and contracting small time slices without modifying frequency content, (4) introduction of a small quantity of frequency noise 410, (5) introduction of small changes in silence duration 412 lengthening or shortening pauses, (6) introduction of a small quantity of phase shift noise 414 and (7) introduction of other types of interference 416. Known techniques for implementing these examples are employed. Any combination of the foregoing and similar examples may be used by signal modification engine 106.

The amount of degradation (in resulting audio/voice communication stream 102′) from applying these interferences can be varied (controllable) to suit the use and security requirements of the network 100 (environment). In this way, the present invention voice data security system 104 prevents many direct attacks on receiving audio communication equipment 108, 110, 112 and prevents unauthorized use of a data network via voice channels.

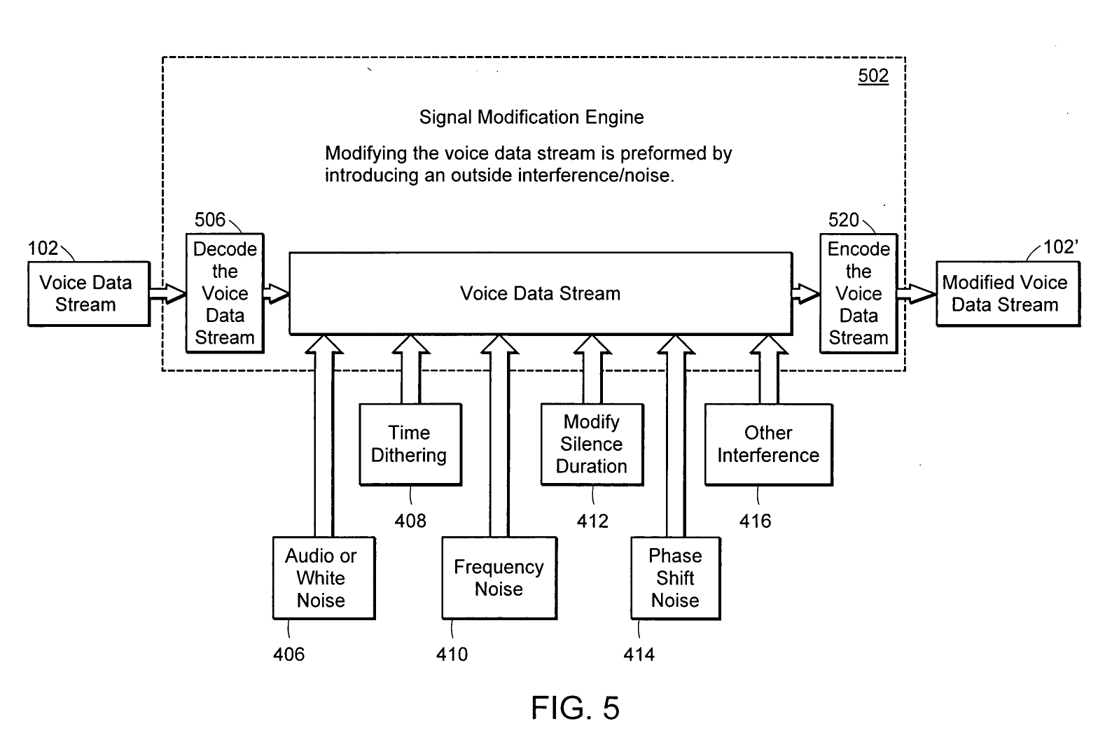

FIG. 5 shows an expanded view of a signal modification engine 502 that may decode and re-encode the voice data stream 102 during the process of generating a secured/modified voice data stream 102′. The signal modification engine 502 for the most part is similar to the signal modification engine 106 of FIG. 4. However, the signal modification engine 502 may decode the incoming voice data stream 102 in step 506 prior to introducing interferences 406, 408, 410, 412, 414 and/or 416. For example, incoming voice data stream 102 is decoded into an audio wave form of certain or predetermined format, and then interferences 406, 408, 410, 412, 414, and/or 416 are applied.

After the signal modification engine 502 introduces the interference, the signal modification engine 502 may re-encode the modified voice data stream 102′ to the original format of the voice data stream 102 in step 520. The resulting modified voice data stream 102′ is forwarded to the appropriate destination for voice/audio communication connection as described and shown in FIGS. 1 and 2.

In another embodiment, transcoding and transmogrification can be combined. The signal modification engine 502 re-encodes the modified voice data stream 102′ to a different encoding format (at step 520). The resulting modified voice data stream 102′ in the different format is forwarded to the appropriate destination for voice/audio communication connection as shown in FIGS. 1 and 2. In this way, the present invention is capable of providing secure voice data streams as well as reformatting the voice data stream for increased security if the encoding is randomly lossy. Transcoding with a randomly lossy encoder without transmogrification may also be employed to introduce controlled degradation and hence voice data stream security of the present invention.

It will be apparent to those of ordinary skill in the art that methods involved in the present invention may be embodied in a computer program product that includes a computer readable and usable medium. For example, such a computer usable medium may consist of a read only memory device, such as a CD ROM disk or conventional ROM devices, or a random access memory, such as a hard drive device or a computer diskette, having a computer readable program code implementing steps 304, 306 and 308 of FIG. 3 stored thereon.

While this invention has been particularly shown and described with references to preferred embodiments thereof, it will be understood by those skilled in the art that various changes in form and details may be made therein without departing from the scope of the invention encompassed by the appended claims.

What is claimed is:

1. A voice data security system, comprising:
a voice data stream; and
a signal modification engine responsive to the voice data stream, the signal modification engine modifying the voice data stream in a manner such that audible difference to the voice data stream is controllable.

2. The system of claim 1, wherein the signal modification engine introduces noise data into the voice data stream.

3. The system of claim 1, wherein the signal modification engine applies time dithering to the voice data stream.

4. The system of claim 3, wherein the time dithering maintains a frequency content of the voice data stream.

5. The system of claim 1, wherein the signal modification engine introduces frequency noise data into the voice data stream.

6. The system of claim 1, wherein the signal modification engine introduces phase shift noise data into the voice data stream.

7. The system of claim 1, wherein the signal modification engine modifies a silence duration of the voice data stream.

8. The system of claim 1, wherein the signal modification engine further decodes the voice data stream to a common format prior to modifying the voice data stream, and encodes the voice data stream after modifying the voice data stream.

9. The system of claim 8, wherein the signal modification engine encoding the voice data stream restores the voice data stream to an original format.

10. The system of claim 8, wherein the signal modification engine transcoding the voice data stream encodes a different format for the voice data stream.

11. The system of claim 1, wherein the signal modification engine provides the modified voice data stream to a telephony network.

12. The system of claim 11, wherein the telephony network includes voice-over IP equipment.

13. A voice data security method, comprising the steps of:
receiving a voice data stream; and
modifying the voice data stream in a manner such that audible difference of the voice data stream is controllable.

14. The method of claim 13, wherein the step of modifying includes introducing noise data into the voice data stream.

15. The method of claim 13, wherein the step of modifying includes applying time dithering to the voice data stream.

16. The method of claim 15, wherein the step of applying time dithering maintains a frequency content of the voice data stream.

17. The method of claim 13, wherein the step of modifying includes introducing frequency noise data into the voice data stream.

18. The method of claim 13, wherein the step of modifying includes introducing phase shift noise data into the voice data stream.

19. The method of claim 13, wherein the step of modifying includes modifying a silence duration of the voice data stream.

20. The method of claim 13, further comprising the steps of:
decoding the voice data stream to a common format prior to modifying the voice data stream; and
encoding the voice data stream after modifying the voice data stream.

21. The method of claim 20, wherein the step of encoding the voice data stream restores the voice data stream to an original format.

22. The method of claim 20, wherein the step of encoding the voice data stream encodes a new format for the voice data stream.

23. The method of claim 13, further comprising the step of providing the modified voice data stream to a telephony network.

24. The method of claim 23, wherein the telephony network includes voice-over IP equipment.

25. Computer network apparatus, comprising:
means for receiving a voice data stream indicative of audio communication; and
audio communication security means for preventing unauthorized use of a subject network, said security means modifying the received voice data stream to form working voice data, audible difference between the received voice data stream and the formed working voice data being controllable.

26. The system of claim 25, wherein the subject network is a data network.

27. The system of claim 25, wherein the subject network includes voice-over IP equipment.
